(19) United States
(12) Patent Application Publication
(10) Pub. No.: US 2026/0094575 A1
(43) Pub. Date: Apr. 2, 2026

(54) GATE DRIVER, DISPLAY DEVICE INCLUDING THE GATE DRIVER, AND ELECTRONIC DEVICE INCLUDING THE DISPLAY DEVICE

(71) Applicant: Samsung Display Co., LTD., Yongin-si (KR)

(72) Inventors: JI-SUN KIM, Yongin-si (KR); KYUNGHOON CHUNG, Yongin-si (KR); SUNHWA LEE, Yongin-si (KR)

(21) Appl. No.: 19/239,053

(22) Filed: Jun. 16, 2025

(30) Foreign Application Priority Data
Sep. 27, 2024 (KR) 10-2024-0131297

(51) Int. Cl. G09G 3/3266; G09G 3/3233

(52) U.S. Cl. CPC G09G 3/3266; G09G 3/3233; G09G 2300/0819; G09G 2300/0852; G09G 2300/0861; G09G 2310/0286; G09G 2310/08; G09G 2330/021

(57) ABSTRACT

A gate driver includes a plurality of stages. Each of the stages includes first to seventh transistors. The each of the stages outputs a compensation gate signal and a data write gate signal in response to an input signal, a clock signal and a gate clock signal.

This application claims priority to Korean Patent Application No. 10-2024-0131297, filed on Sep. 27, 2024, and all the benefits accruing therefrom under 35 U.S. C. § 119, the content of which in its entirety is herein incorporated by reference.

### BACKGROUND

### 1. Field

Embodiments of the invention relates to a gate driver, a display device including the gate driver, and an electronic device including the display device. More particularly, the invention relates to a gate driver, a display device including the gate driver, and an electronic device including the display device for reducing a dead space and a power consumption.

### 2. Description of the Related Art

In general, a display device includes a display panel and a display panel driver. The display panel may include gate lines, data lines, emission lines, and pixels. The display panel driver may include a gate driver for providing a gate signal to the gate lines, a data driver for providing a data voltage to the data lines, an emission driver for providing an emission signal to the emission lines, and a driving controller for controlling the gate driver, the data driver, and the emission driver.

The gate driver may include a plurality of stages, and each of the stages may include a plurality of elements. For example, the elements in each of the stages may be transistors, signal lines, and voltage lines. The more elements there are, the greater a dead space and a power consumption of the gate driver.

### SUMMARY

Embodiments of the invention provide a gate driver having simplified configurations to reduce a dead space and a power consumption.

Embodiments of the invention provide a display device including the gate driver.

Embodiments of the invention provide an electronic device including the display device.

In an embodiment of a gate driver according to the invention, the gate driver includes a plurality of stages. In such an embodiment, each of the stages includes a first transistor including a gate electrode which receives a clock signal, a first electrode which receives an input signal, and a second electrode connected to a control node, a second transistor including a gate electrode connected to the control node, a first electrode which receives a second low gate voltage, and a second electrode connected to an inversion control node, a third transistor including a gate electrode connected to the control node, a first electrode which receives a high gate voltage, and a second electrode connected to the inversion control node, a fourth transistor including a gate electrode connected to the control node, a first electrode which receives the second low gate voltage, and a second electrode connected to a compensation gate output node from which a compensation gate signal is output, a fifth transistor including a gate electrode connected to the inversion control node, a first electrode which receives the high gate voltage, and a second electrode connected to the compensation gate output node, a sixth transistor including a gate electrode connected to the compensation gate output node, a first electrode which receives the high gate voltage, and a second electrode connected to a data write gate output node from which a data write gate signal is output, and a seventh transistor including a gate electrode connected to the inversion control node, a first electrode which receives a gate clock signal, and a second electrode connected to the data write gate output node.

In an embodiment, the input signal may be a gate start signal or a previous compensation gate signal.

In an embodiment, the first transistor and the third to seventh transistors may be p-channel metal-oxide-semiconductor (PMOS) transistors, and the second transistor may be an n-channel metal-oxide-semiconductor (NMOS) transistor.

In an embodiment, the control node may include a first control node and a second control node, and each of the stages may further include an eighth transistor including a gate electrode which receives a first low gate voltage, a first electrode connected to the first control node, and a second electrode connected to the second control node.

In an embodiment, the gate electrode of the second transistor may be connected to the first control node.

In an embodiment, the gate electrode of the second transistor may be connected to the second control node.

In an embodiment, the inversion control node may include a first inversion control node and a second inversion control node, and each of the stages may further include a ninth transistor including a gate electrode which receives the first low gate voltage, a first electrode connected to the first inversion control node, and a second electrode connected to the second inversion control node.

In an embodiment, the eighth transistor and the ninth transistor may be PMOS transistors.

In an embodiment, each of the stages may further include a first capacitor including a first electrode connected to the second control node and a second electrode connected to the compensation gate output node, and a second capacitor including a first electrode connected to the second inversion control node and a second electrode connected to the data write gate output node.

In an embodiment, the first low gate voltage may be equal to the second low gate voltage.

In an embodiment, the first low gate voltage may be higher than the second low gate voltage.

In an embodiment, an active pulse of the compensation gate signal may include an active pulse of the data write gate signal.

In an embodiment, an active pulse of the compensation gate signal may have a high level, and the active pulse of the data write gate signal may have a low level.

In an embodiment of a display device according to the invention, the display device includes a display panel including a pixel, a data driver which provides a data voltage to the pixel, a gate driver which provides a gate signal to the pixel, an emission driver which provides an emission signal to the pixel, and a driving controller which controls the data driver, the gate driver, and the emission driver. In such an embodiment, the gate driver includes a plurality of stages. In such an embodiment, each of the stages includes a first transistor including a gate electrode which receives a clock signal, a first electrode which receives an input signal, and a second electrode connected to a control node, a second transistor including a gate electrode connected to the control node, a first electrode which receives a second low gate voltage, and a second electrode connected to an inversion control node, a third transistor including a gate electrode connected to the control node, a first electrode which receives a high gate voltage, and a second electrode connected to the inversion control node, a fourth transistor including a gate electrode connected to the control node, a first electrode which receives the second low gate voltage, and a second electrode connected to a compensation gate output node from which a compensation gate signal is output, a fifth transistor including a gate electrode connected to the inversion control node, a first electrode which receives the high gate voltage, and a second electrode connected to the compensation gate output node, a sixth transistor including a gate electrode connected to the compensation gate output node, a first electrode which receives the high gate voltage, and a second electrode connected to a data write gate output node from which a data write gate signal is output, and a seventh transistor including a gate electrode connected to the inversion control node, a first electrode which receives a gate clock signal, and a second electrode connected to the data write gate output node.

In an embodiment, the input signal may be a gate start signal or a previous compensation gate signal.

In an embodiment, the first transistor and the third to seventh transistors may be PMOS transistors, and the second transistor may be an NMOS transistor.

In an embodiment, the control node may include a first control node and a second control node, and each of the stages may further include an eighth transistor including a gate electrode which receives a first low gate voltage, a first electrode connected to the first control node, and a second electrode connected to the second control node.

In an embodiment, the gate electrode of the second transistor may be connected to the first control node.

In an embodiment, the gate electrode of the second transistor may be connected to the second control node.

In an embodiment of an electronic device according to the invention, the electronic device includes a display panel including a pixel, a data driver which provides a data voltage to the pixel, a gate driver which provides a gate signal to the pixel, an emission driver which provides an emission signal to the pixel, a driving controller which controls the data driver, the gate driver, and the emission driver, and a processor which controls the driving controller. In such an embodiment, the gate driver includes a plurality of stages. In such an embodiment, each of the stages includes a first transistor including a gate electrode which receives a clock signal, a first electrode which receives an input signal, and a second electrode connected to a control node, a second transistor including a gate electrode connected to the control node, a first electrode which receives a second low gate voltage, and a second electrode connected to an inversion control node, a third transistor including a gate electrode connected to the control node, a first electrode which receives a high gate voltage, and a second electrode connected to the inversion control node, a fourth transistor including a gate electrode connected to the control node, a first electrode which receives the second low gate voltage, and a second electrode connected to a compensation gate output node from which a compensation gate signal is output, a fifth transistor including a gate electrode connected to the inversion control node, a first electrode which receives the high gate voltage, and a second electrode connected to the compensation gate output node, a sixth transistor including a gate electrode connected to the compensation gate output node, a first electrode which receives the high gate voltage, and a second electrode connected to a data write gate output node from which a data write gate signal is output, and a seventh transistor including a gate electrode connected to the inversion control node, a first electrode which receives a gate clock signal, and a second electrode connected to the data write gate output node.

According to embodiments of the gate driver, the display device, and the electronic device, the gate driver may output a compensation gate signal and a data write gate signal while including a small number of components. Accordingly, the configurations of the gate driver may be simplified such that a dead space and a power consumption of the gate driver may be reduced.

### BRIEF DESCRIPTION OF THE DRAWINGS

The above and other features of embodiments of the invention will become more apparent by describing in detailed embodiments thereof with reference to the accompanying drawings, in which:

FIG. 1 is a block diagram showing a display device according to embodiments of the invention;

FIG. 2 is a block diagram showing an embodiment of a pixel of FIG. 1;

FIG. 3 is a signal timing diagram showing gate signals and an emission signal applied to a pixel of FIG. 2;

FIG. 4 is a block diagram showing an embodiment of a gate driver of FIG. 1;

FIG. 5 is a signal timing diagram showing an operation of the gate driver of FIG. 4;

FIG. 6 is a circuit diagram showing an embodiment of the stage of FIG. 4;

FIG. 7 is a signal timing diagram showing an operation of the stage of FIG. 6;

FIG. 8 is a circuit diagram showing an operation of the stage of FIG. 6 at a first time point of FIG. 7;

FIG. 9 is a circuit diagram showing an operation of the stage of FIG. 6 at a second time point of FIG. 7;

FIG. 10 is a circuit diagram showing an operation of the stage of FIG. 6 at a third time point of FIG. 7;

FIG. 11 is a circuit diagram showing an embodiment of the stage of FIG. 4;

FIG. 12 is a block diagram showing an embodiment of an electronic device; and

FIG. 13 is a diagram showing an embodiment in which an electronic device of FIG. 12 is implemented as a smart watch.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the invention will be described in more detail with reference to the accompanying drawings.

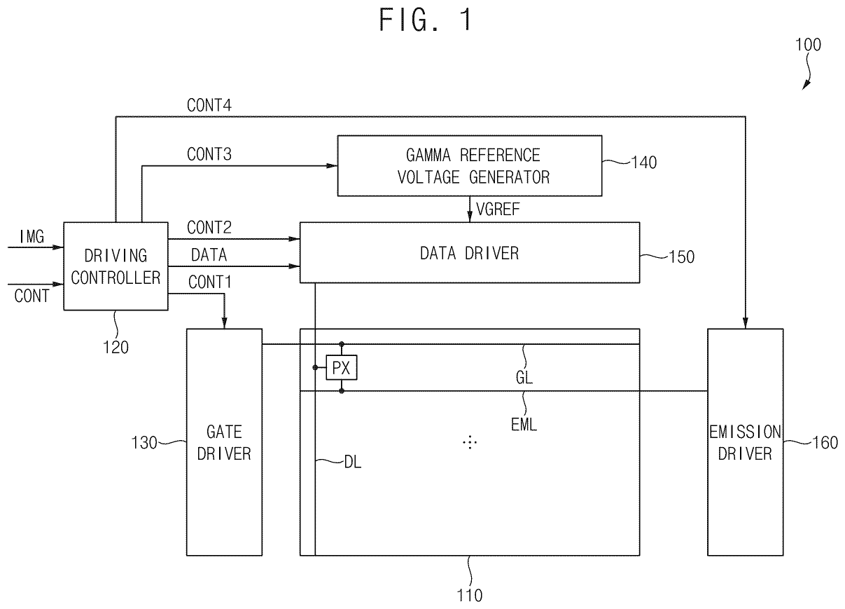

FIG. 1 is a block diagram showing a display device 100 according to embodiments of the invention.

Referring to FIG. 1, an embodiment of a display device 100 may include a display panel 110 and a display panel driver. The display panel driver may include a driving controller 120, a gate driver 130, a gamma reference voltage generator 140, a data driver 150, and an emission driver 160.

The display panel 110 may include a display area for displaying an image and a peripheral area disposed adjacent to the display area.

For example, in an embodiment, the display panel 110 may be an organic light-emitting diode display panel including an organic light emitting diode. In another embodiment, for example, the display panel 110 may be a quantum-dot organic light emitting diode display panel including an organic light emitting diode and a quantum-dot color filter. In another embodiment, for example, the display panel 110 may be a quantum-dot nano light emitting diode display panel including a nano light emitting diode and a quantum-dot color filter.

The display panel 110 may include gate lines GL, data lines DL, emission lines EML, and pixels PX electrically connected to the gate lines GL, the data lines DL, and the emission lines EML, respectively. The gate lines GL may extend in a first direction, the data lines DL may extend in a second direction crossing the first direction, and the emission lines EML may extend in the first direction.

The driving controller 120 may receive input image data IMG and an input control signal CONT from an external device. In an embodiment, for example, the input image data IMG may include red image data, green image data and blue image data. The input image data IMG may include white image data. The input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 120 may generate a first control signal CONT1, a second control signal CONT2, a third control signal CONT3, a fourth control signal CONT4, and a data signal DATA based on the input image data IMG and the input control signal CONT.

The driving controller 120 may generate the first control signal CONT1 for controlling an operation of the gate driver 130 based on the input control signal CONT, and output the first control signal CONT1 to the gate driver 130. The first control signal CONT1 may include a vertical start signal and a gate clock signal.

The driving controller 120 may generate the second control signal CONT2 for controlling an operation of the data driver 150 based on the input control signal CONT, and output the second control signal CONT2 to the data driver 150. The second control signal CONT2 may include a horizontal start signal and a load signal.

The driving controller 120 may generate the data signal DATA based on the input image data IMG. The driving controller 120 may output the data signal DATA to the data driver 150.

The driving controller 120 may generate the third control signal CONT3 for controlling an operation of the gamma reference voltage generator 140 based on the input control signal CONT, and output the third control signal CONT3 to the gamma reference voltage generator 140.

The driving controller 120 may generate the fourth control signal CONT4 for controlling an operation of the emission driver 160 based on the input control signal CONT, and output the fourth control signal CONT4 to the emission driver 160.

The gate driver 130 may generate gate signals for driving the gate lines GL in response to the first control signal CONT1 received from the driving controller 120. The gate driver 130 may output the gate signals to the gate lines GL.

The gamma reference voltage generator 140 may generate a gamma reference voltage VGREF in response to the third control signal CONT3 received from the driving controller 120. The gamma reference voltage generator 140 may provide the gamma reference voltage VGREF to the data driver 150. The gamma reference voltage VGREF may have a value corresponding to each data signal DATA.

In an embodiment, for example, the gamma reference voltage generator 140 may be disposed within (or integrated into) the driving controller 120 or may be disposed within the data driver 150.

The data driver 150 may receive the second control signal CONT2 and the data signal DATA from the driving controller 120, and receive the gamma reference voltage VGREF from the gamma reference voltage generator 140. The data driver 150 may convert the data signal DATA into a data voltage having an analog type using the gamma reference voltage VGREF. The data driver 150 may output the data voltage to the data line DL.

The emission driver 160 may generate emission signals for driving the emission lines EML in response to the fourth control signal CONT4 received from the driving controller 120. The emission driver 160 may output the emission signals to the emission lines EML.

In FIG. 1, for a convenience of illustration and description, an embodiment where the gate driver 130 is disposed on a first side of the display panel 110 and the emission driver 160 is disposed on a second side of the display panel 110 is shown, but the invention is not limited thereto. In another embodiment, for example, both the gate driver 130 and the emission driver 160 may be disposed on the first side of the display panel 110. In another embodiment, for example, both the gate driver 130 and the emission driver 160 may be disposed on both sides of the display panel 110. In another embodiment, for example, the gate driver 130 and the emission driver 160 may be formed integrally with each other as a single chip or package.

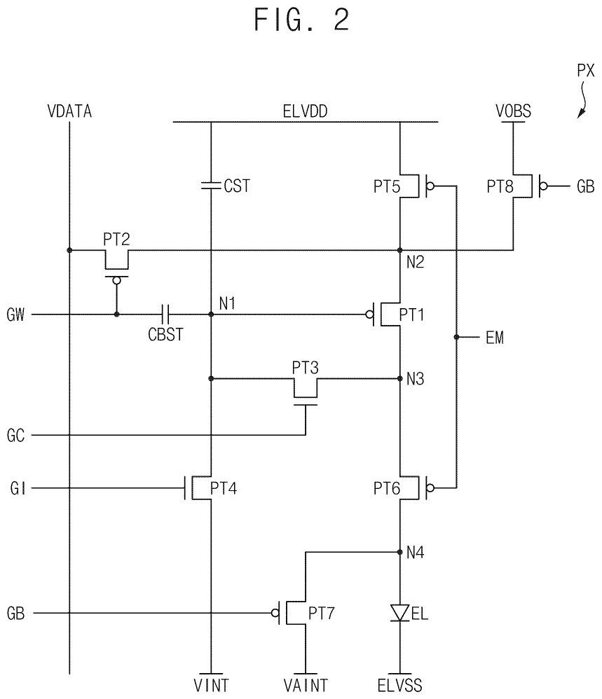

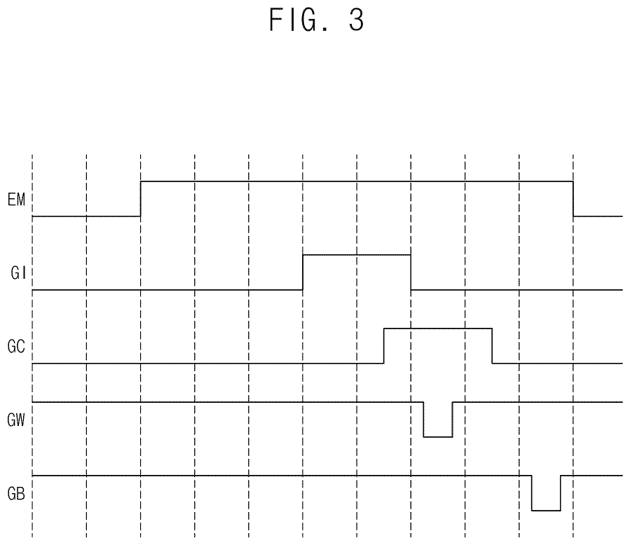

FIG. 2 is a block diagram showing an embodiment of a pixel PX of FIG. 1. FIG. 3 is a signal timing diagram showing gate signals and an emission signal applied to a pixel PX of FIG. 2.

Referring to FIGS. 1 to 3, pixels PX may be hybrid oxide polycrystaline (HOP) pixels. The HOP pixel may include p-channel metal-oxide-semiconductor (PMOS) transistors and n-channel metal-oxide-semiconductor (NMOS) transistors.

In an embodiment, as shown in FIG. 2, each of the pixels PX may include first to eighth pixel transistors PT1 to PT8, a storage capacitor CST, a boost capacitor CBST, and a light emitting element EL. The first pixel transistor PT1, the second pixel transistor PT2, and the fifth to eighth pixel transistors PT5 to PT8 may be the PMOS transistors, and the third pixel transistor PT3 and the fourth pixel transistor PT4 may be the NMOS transistors.

The PMOS transistor may be turned on in response to a signal having a low level, and may be turned off in response to a signal having a high level. That is, an active pulse of the PMOS transistor may have the low level, and an inactive pulse of the PMOS transistor may have the high level. The NMOS transistor may be turned on in response to a signal having the high level, and may be turned off in response to a signal having the low level. That is, an active pulse of the NMOS transistor may have the high level, and an inactive pulse of the NMOS transistor may have the low level.

The first pixel transistor PT1 may include a gate electrode connected to a first node N1, a first electrode connected to a second node N2, and a second electrode connected to a third node N3.

The second pixel transistor PT2 may include a gate electrode that receives a data write gate signal GW, a first electrode that receives a data voltage VDATA, and a second electrode connected to the second node N2.

The third pixel transistor PT3 may include a gate electrode that receives a compensation gate signal GC, a first electrode connected to the first node N1, and a second electrode connected to the third node N3.

The fourth pixel transistor PT4 may include a gate electrode that receives an initialization gate signal GI, a first electrode that receives an initialization voltage VINT, and a second electrode connected to the first node N1.

The fifth pixel transistor PT5 may include a gate electrode that receives an emission signal EM, a first electrode that receives a high power supply voltage ELVDD, and a second electrode connected to the second node N2.

The sixth pixel transistor PT6 may include a gate electrode that receives the emission signal EM, a first electrode connected to the third node N3, and a second electrode connected to a fourth node N4.

The seventh pixel transistor PT7 may include a gate electrode that receives a bias gate signal GB, a first electrode that receives an anode initialization voltage VAINT, and a second electrode connected to the fourth node N4.

The eighth pixel transistor PT8 may include a gate electrode that receives the bias gate signal GB, a first electrode that receives a bias voltage VOBS, and a second electrode connected to the second node N2.

The storage capacitor CST may include a first electrode that receives the high power supply voltage ELVDD and a second electrode connected to the first node N1.

The boost capacitor CBST may include a first electrode that receives the data write gate signal GW and a second electrode connected to the first node N1.

The light emitting element EL may include an anode connected to the fourth node N4 and a cathode that receives a low power supply voltage ELVSS.

Since the emission signal EM is applied to the fifth pixel transistor PT5 and the sixth pixel transistor PT6, and the fifth pixel transistor PT5 and the sixth pixel transistor PT6 are the PMOS transistors, an active pulse of the emission signal EM may have the low level, and an inactive pulse of the emission signal EM may have the high level.

Since the initialization gate signal GI is applied to the fourth pixel transistor PT4, and the fourth pixel transistor PT4 is the NMOS transistor, an active pulse of the initialization gate signal GI may have the high level, and an inactive pulse of the initialization gate signal GI may have the low level.

Since the compensation gate signal GC is applied to the third pixel transistor PT3, and the third pixel transistor PT3 is the NMOS transistor, an active pulse of the compensation gate signal GC may have the high level, and an inactive pulse of the compensation gate signal GC may have the low level.

Since the data write gate signal GW is applied to the second pixel transistor PT2, and the second pixel transistor PT2 is the PMOS transistor, an active pulse of the data write gate signal GW may have the low level, and an inactive pulse of the data write gate signal GW may have the high level.

Since the bias gate signal GB is applied to the seventh pixel transistor PT7 and the eighth pixel transistor PT8, and the seventh pixel transistor PT7 and the eighth pixel transistor PT8 are the PMOS transistors, an active pulse of the bias gate signal GB may have the low level, and an inactive pulse of the bias gate signal GB may have the high level.

The inactive pulse of the emission signal EM may include the active pulse of the initialization gate signal GI, the active pulse of the compensation gate signal GC, the active pulse of the data write gate signal GW, and the active pulse of the bias gate signal GB.

The active pulse of the compensation gate signal GC may include the active pulse of the data write gate signal GW.

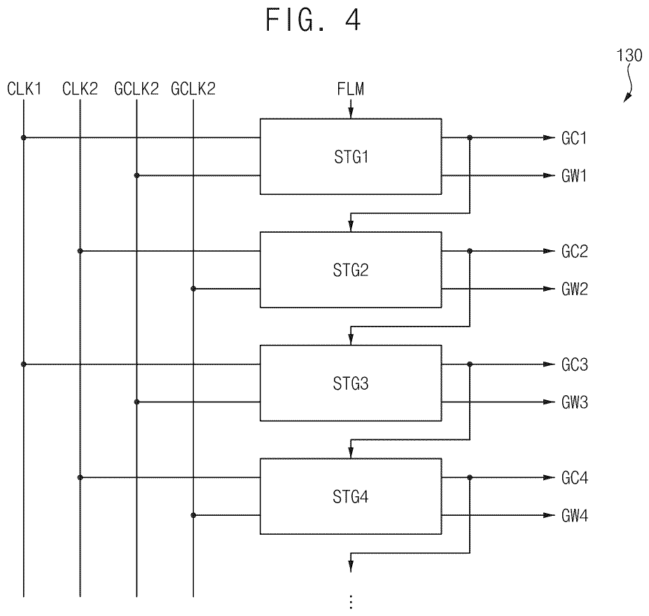

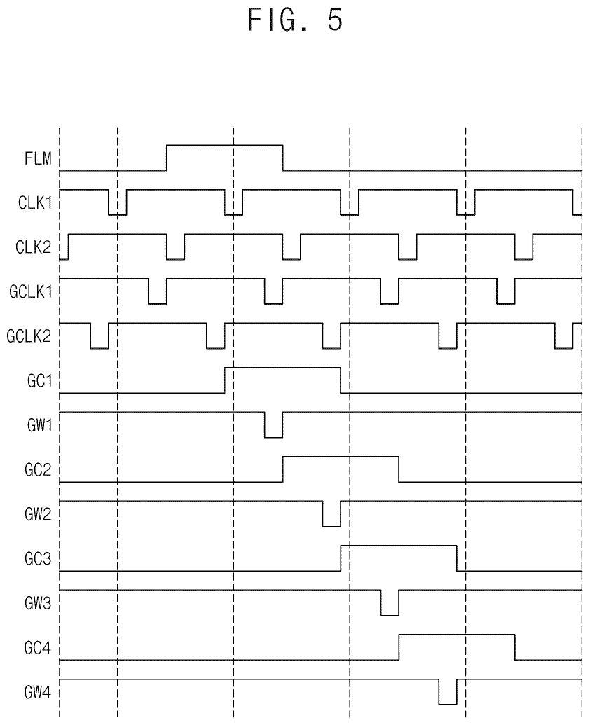

FIG. 4 is a block diagram showing an embodiment of a gate driver 130 of FIG. 1. FIG. 5 is a signal timing diagram showing an operation of the gate driver 130 of FIG. 4.

Referring to FIGS. 1 to 5, an embodiment of a gate driver 130 may include a plurality of stages STG1, STG2, STG3, STG4, . . . . The stages STG1, STG2, STG3, STG4, . . . may receive a gate start signal FLM, a first clock signal CLK1, a second clock signal CLK2, a first gate clock signal GCLK1, and a second gate clock signal GCLK2. The stages STG1, STG2, STG3, STG4, . . . may sequentially generate and output compensation gate signals GC1, GC2, GC3, GC4, . . . and data write gate signals GW1, GW2, GW3, GW4, . . .

A first stage STG1 may receive the gate start signal FLM as an input signal, and subsequent stages STG2, STG3, STG4, . . . may receive previous compensation gate signals GC1, GC2, GC3, GC4, . . . as the input signals.

In an embodiment, for example, the first stage STG1 may receive the gate start signal FLM as the input signal in response to the first clock signal CLK1. The first stage STG1 may generate and output a voltage of an internal node of the first stage STG1 as a first compensation gate signal GC1, and may generate and output the first gate clock signal GCLK1 as a first data write gate signal GW1.

In an embodiment, for example, the second stage STG2 may receive the first compensation gate signal GC1 as the input signal in response to the second clock signal CLK2. The second stage STG2 may generate and output the voltage of the internal node of the second stage STG2 as the second compensation gate signal GC2, and may generate and output the second gate clock signal GCLK2 as the second data write gate signal GW2.

In an embodiment, for example, the third stage STG3 may receive the second compensation gate signal GC2 as the input signal in response to the first clock signal CLK1. The third stage STG3 may generate and output a voltage of an internal node of the third stage STG3 as a third compensation gate signal GC3, and may generate and output the first gate clock signal GCLK1 as a third data write gate signal GW3.

In an embodiment, for example, the fourth stage STG4 may receive the third compensation gate signal GC3 as the input signal in response to the second clock signal CLK2. The fourth stage STG4 may generate and output a voltage of an internal node of the fourth stage STG4 as the fourth compensation gate signal GC4, and may generate and output the second gate clock signal GCLK2 as a fourth data write gate signal GW4.

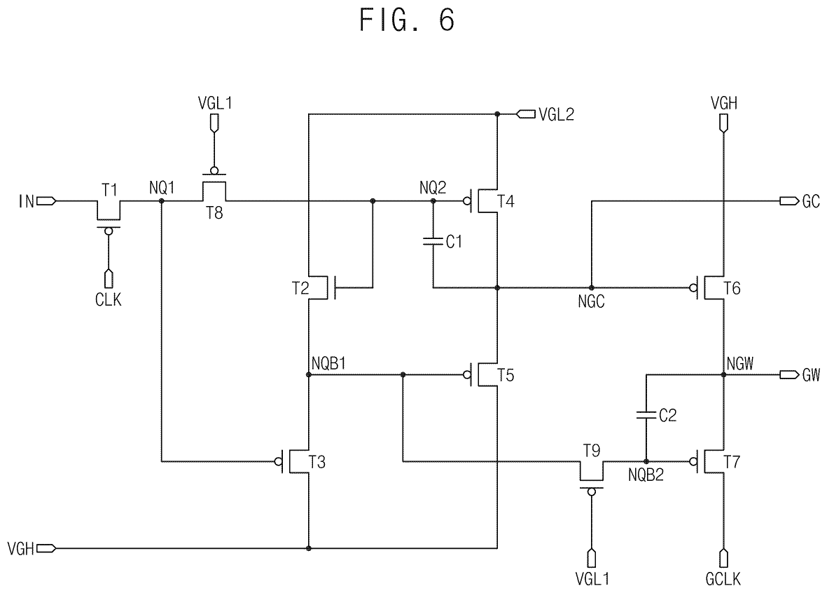

FIG. 6 is a circuit diagram showing an embodiment of the stage of FIG. 4.

Referring to FIGS. 1 to 6, a gate driver 130 according to embodiments of the invention may include a plurality of stages. Each of the stages may include first to seventh transistors T1 to T7. The each of the stages may further include an eighth transistor T8. The each of the stages may further include a ninth transistor T9. The each of the stages may further include a first capacitor C1. The each of the stages may further include a second capacitor C2.

The first transistor T1 and the third to ninth transistors T3 to T9 may be PMOS transistors. The second transistor T2 may be an NMOS transistor.

A control node NQ1, NQ2 in each of the stages may include a first control node NQ1 and a second control node NQ2. An inversion control node NQB1, NQB2 in each of the stages may include a first inversion control node NQB1 and a second inversion control node NQB2.

The first transistor T1 may include a gate electrode that receives a clock signal CLK, a first electrode that receives an input signal IN, and a second electrode connected to a first control node NQ1. The input signal IN may be a gate start signal or a previous compensation gate signal.

The second transistor T2 may include a gate electrode, a first electrode that receives a second low gate voltage VGL2, and a second electrode connected to a first inversion control node NQB1. In an embodiment, the gate electrode of the second transistor T2 may be connected to the second control node NQ2.

The third transistor T3 may include a gate electrode connected to the first control node NQ1, a first electrode that receives a high gate voltage VGH, and a second electrode connected to the first inversion control node NQB1.

The fourth transistor T4 may include a gate electrode connected to the second control node NQ2, a first electrode that receives the second low gate voltage VGL2, and a second electrode connected to a compensation gate output node NGC from which a compensation gate signal GC is output.

The fifth transistor T5 may include a gate electrode connected to the first inversion control node NQB1, a first electrode that receives the high gate voltage VGH, and a second electrode connected to the compensation gate output node NGC.

The sixth transistor T6 may include a gate electrode connected to the compensation gate output node NGC, a first electrode that receives the high gate voltage VGH, and a second electrode connected to a data write gate output node NGW from which a data write gate signal GW is output.

The seventh transistor T7 may include a gate electrode connected to the second inversion control node NQB2, a first electrode that receives a gate clock signal GCLK, and a second electrode connected to the data write gate output node NGW.

The eighth transistor T8 may include a gate electrode that receives a first low gate voltage VGL1, a first electrode connected to the first control node NQ1, and a second electrode connected to the second control node NQ2.

The ninth transistor T9 may include a gate electrode that receives the first low gate voltage VGL1, a first electrode connected to the first inversion control node NQB1, and a second electrode connected to the second inversion control node NQB2.

The first capacitor C1 may include a first electrode connected to the second control node NQ2 and a second electrode connected to the compensation gate output node NGC.

The second capacitor C2 may include a first electrode connected to the second inversion control node NQB2 and a second electrode connected to the data write gate output node NGW.

The high gate voltage VGH may be greater (or higher) than the first low gate voltage VGL1 and the second low gate voltage VGL2. The first low gate voltage VGL1 may be greater (or higher) than the second low gate voltage VGL2.

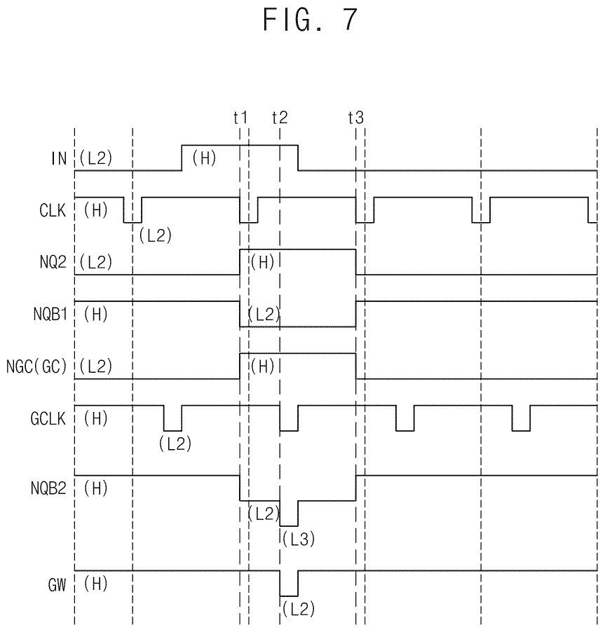

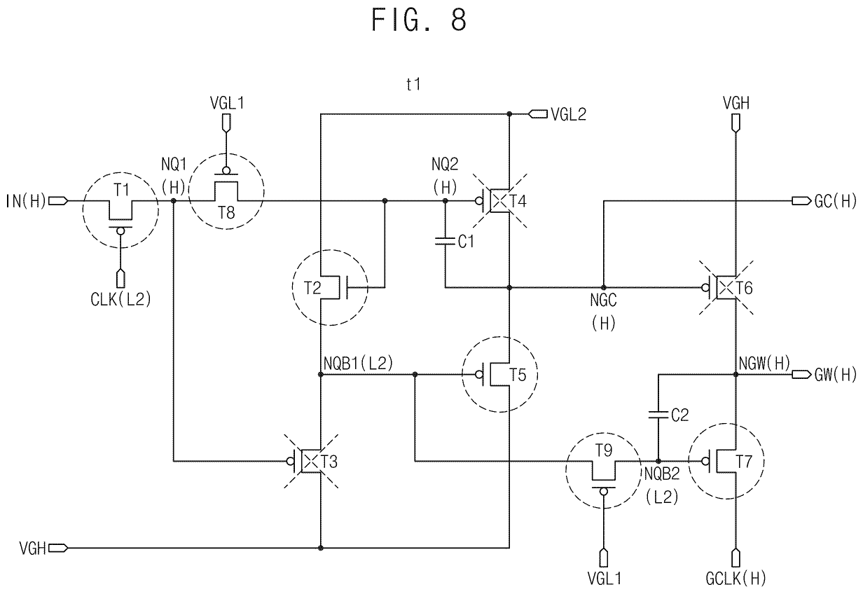

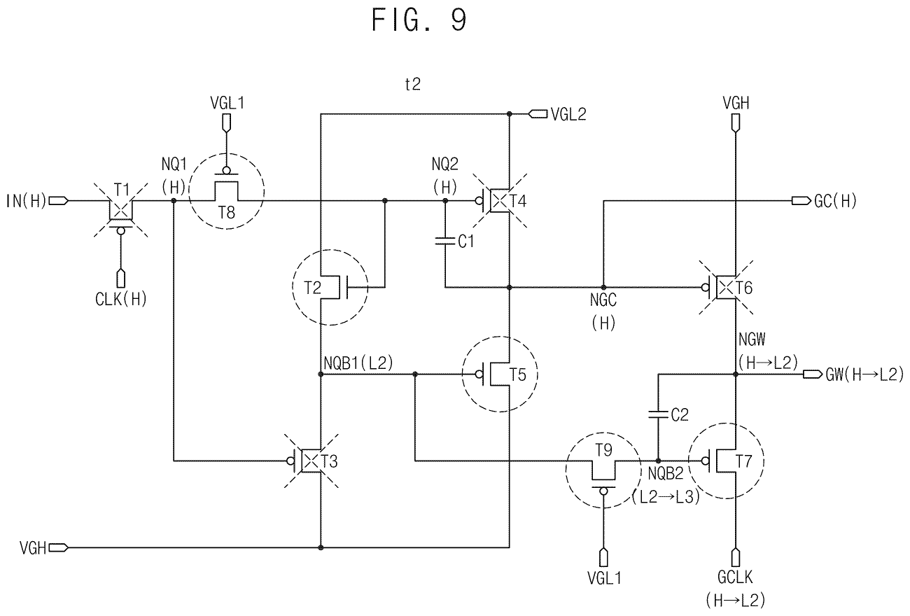

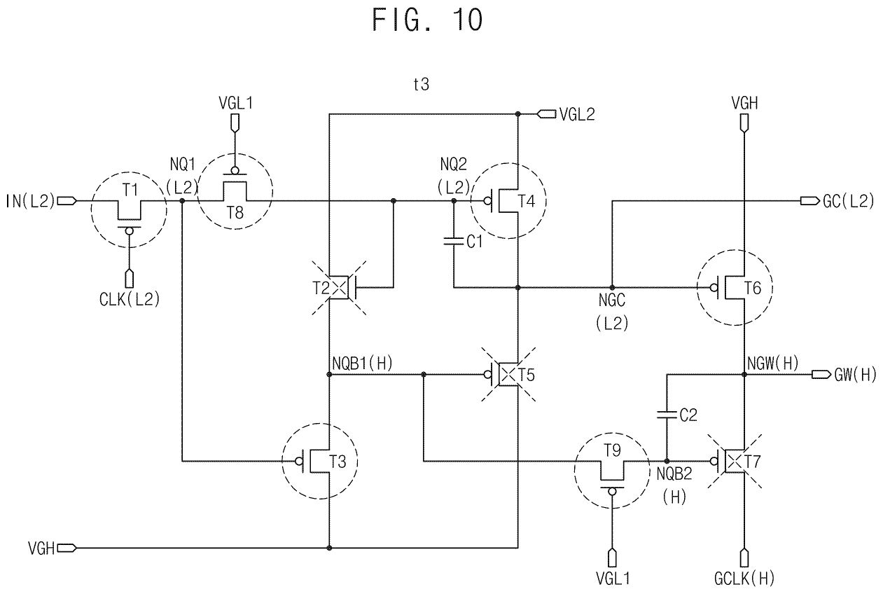

FIG. 7 is a signal timing diagram showing an operation of the stage of FIG. 6. FIG. 8 is a circuit diagram showing an operation of the stage of FIG. 6 at a first time point t1 of FIG. 7. FIG. 9 is a circuit diagram showing an operation of the stage of FIG. 6 at a second time point t2 of FIG. 7. FIG. 10 is a circuit diagram showing an operation of the stage of FIG. 6 at a third time point t3 of FIG. 7.

The high gate voltage VGH may have a high level H, the first low gate voltage VGL1 may have a first low level, and the second low gate voltage VGL2 may have a second low level L2.

Referring to FIGS. 7 and 8, at a first time point t1, the input signal IN may have the high level H, the clock signal CLK may have the second low level L2, and the gate clock signal GCLK may have the high level H.

Accordingly, the first transistor T1 may be turned on in response to the clock signal CLK having the second low level L2 to provide the input signal IN having the high level H to the first control node NQ1. Therefore, a voltage of the first control node NQ1 may have the high level H.

The eighth transistor T8 may be turned on in response to the first low gate voltage VGL1 having the first low level and provide the voltage of the first control node NQ1 having the high level H to the second control node NQ2. Therefore, a voltage of the second control node NQ2 may have the high level H.

The second transistor T2 may be turned on in response to the voltage of the second control node NQ2 having the high level H to provide the second low gate voltage VGL2 to the first inversion control node NQB1. Therefore, a voltage of the first inversion control node NQB1 may have the second low level L2.

The third transistor T3 may be turned off in response to the voltage of the first control node NQ1 having the high level H.

The fourth transistor T4 may be turned off in response to the voltage of the second control node NQ2 having the high level H.

The fifth transistor T5 may be turned on in response to the voltage of the first inversion control node NQB1 having the second low level L2 to provide the high gate voltage VGH to the compensation gate output node NGC. Therefore, a voltage of the compensation gate output node NGC may have the high level H, and the compensation gate signal GC may have the high level H.

The sixth transistor T6 may be turned off in response to the voltage of the compensation gate output node NGC having the high level H.

The ninth transistor T9 may be turned on in response to the first low gate voltage VGL1 having the first low level to provide the voltage of the first inversion control node NQB1 having the second low level L2 to the second inversion control node NQB2. Therefore, a voltage of the second inversion control node NQB2 may have the second low level L2.

The seventh transistor T7 may be turned on in response to the voltage of the second inversion control node NQB2 having the second low level L2 to provide the gate clock signal GCLK having the high level H to the compensation gate output node NGW. Therefore, a voltage of the data write gate output node NGW may have the high level H, and the data write gate signal GW may have the high level H.

Since the voltage of the second control node NQ2 is the high level H and the voltage of the compensation gate output node NGC is the high level H, the first capacitor C1 may not store the voltage.

Since the voltage of the second inversion control node NQB2 is the second low level L2 and the voltage of the data write gate output node NGW is the high level H, the second capacitor C2 may store a difference between the second low level L2 and the high level H.

Referring to FIG. 7 and FIG. 9, at a second time point t2, the input signal IN may have the high level H, the clock signal CLK may have the high level H, and the gate clock signal GCLK may change from the high level H to the second low level L2.

Accordingly, the first transistor T1 may be turned off in response to the clock signal CLK having the high level H. Therefore, the voltage of the first control node NQ1 may maintain the high level H.

The eighth transistor T8 may be turned on in response to the first low gate voltage VGL1 having the first low level to provide the voltage of the first control node NQ1 having the high level H to the second control node NQ2. Therefore, the voltage of the second control node NQ2 may have the high level H.

The second transistor T2 may be turned on in response to the voltage of the second control node NQ2 having the high level H to provide the second low gate voltage VGL2 to the first inversion control node NQB1. Therefore, the voltage of the first inversion control node NQB1 may have the second low level L2.

The third transistor T3 may be turned off in response to the voltage of the first control node NQ1 having the high level H.

The fourth transistor T4 may be turned off in response to the voltage of the second control node NQ2 having the high level H.

The fifth transistor T5 may be turned on in response to the first inversion control node NQB1 having the second low level L2 to provide the high gate voltage VGH to the compensation gate output node NGC. Therefore, the voltage of the compensation gate output node NGC may have the high level H, and the compensation gate signal GC may have the high level H.

The sixth transistor T6 may be turned off in response to the voltage of the compensation gate output node NGC having the high level H.

The ninth transistor T9 may be turned on in response to the first low gate voltage VGL1 having the first low level to provide the voltage of the first inversion control node NQB1 having the second low level L2 to the second inversion control node NQB2. Therefore, the voltage of the second inversion control node NQB2 may have the second low level L2.

The seventh transistor T7 may be turned on in response to the voltage of the second inversion control node NQB2 having the second low level L2 to provide the gate clock signal GCLK changed from the high level H to the second low level L2 to the compensation gate output node NGW. Therefore, the voltage of the data write gate output node NGW may change from the high level H to the second low level L2, and the data write gate signal GW may change from the high level H to the second low level L2.

Since the voltage of the data write gate output node NGW changes from the high level H to the second low level L2, the voltage of the second inversion control node NQB2 may be bootstrapped by the second capacitor C2. Therefore, the voltage of the second inversion control node NQB2 may change from the second low level L2 to a third low level L3 lower than the second low level L2. The ninth transistor T9 may control the voltage of the first inversion control node NQB1 and the voltage of the second inversion control node NQB2. In an embodiment, for example, the ninth transistor T9 may effectively prevent the bootstrapped voltage NQB2 of the second inversion control node NQB2 from being transmitted to the first inversion control node NQB1.

Referring to FIG. 7 and FIG. 10, at a third time point t3, the input signal IN may have the second low level L2, the clock signal CLK may have the second low level L2, and the gate clock signal GCLK may have the high level H.

Accordingly, the first transistor T1 may be turned on in response to the clock signal CLK having the second low level L2 to provide the input signal IN having the second low level L2 to the first control node NQ1. Therefore, the voltage of the first control node NQ1 may have the second low level L2.

The eighth transistor T8 may be turned on in response to the first low gate voltage VGL1 having the first low level to provide the voltage of the first control node NQ1 having the second low level L2 to the second control node NQ2. Therefore, the voltage of the second control node NQ2 may have the second low level L2.

The second transistor T2 may be turned off in response to the voltage of the second control node NQ2 having the second low level L2.

The third transistor T3 may be turned on in response to the voltage of the first control node NQ1 having the second low level L2 to provide the high gate voltage VGH to the first inversion control node NQB1. The voltage of the first inversion control node NQB1 may have the high level H.

The fourth transistor T4 may be turned on in response to the voltage of the second control node NQ2 having the second low level L2 to provide the second low gate voltage VGL2 to the compensation gate output node NGC. Therefore, the voltage of the compensation gate output node NGC may have the second low level L2, and the compensation gate signal GC may have the second low level L2.

The fifth transistor T5 may be turned off in response to the voltage of the first inversion control node NQB1 having the high level H.

The sixth transistor T6 may be turned on in response to the voltage of the compensation gate output node NGC having the second low level L2 to provide the high gate voltage VGH to the data write gate output node NGW. Therefore, the voltage of the data write gate output node NGW may have the high level H, and the data write gate signal GW may have the high level H.

The seventh transistor T7 may be turned off in response to the voltage of the second inversion control node NQB2 having the high level H.

In such an embodiment, as described above, the gate driver 130 may output the compensation gate signal GC and the data write gate signal GW using nine transistors, two capacitors, four clock signals, and three gate voltages. Accordingly, the configurations of the gate driver 130 may be simplified such that a dead space and a power consumption of the gate driver 130 may be reduced.

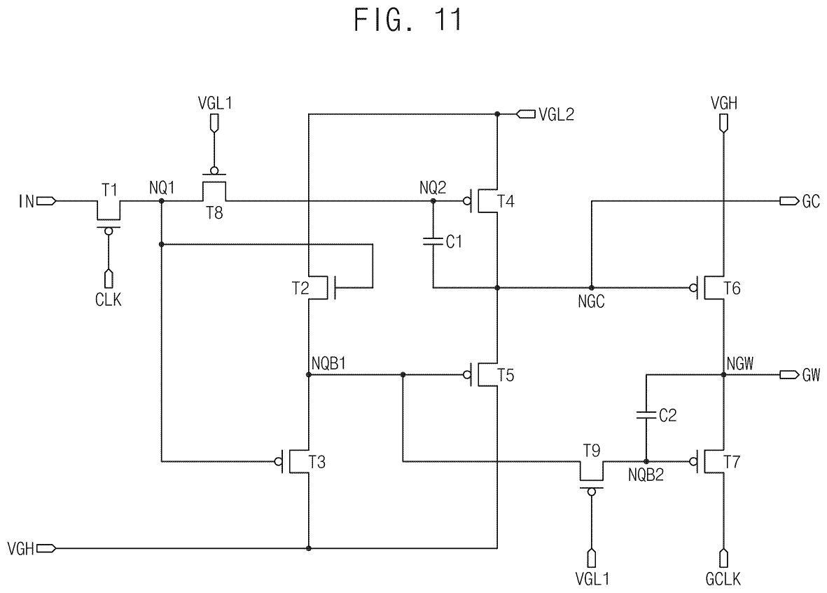

FIG. 11 is a circuit diagram showing an embodiment of the stage of FIG. 4.

Referring to FIGS. 1 to 11, the stage of FIG. 11 has similar configurations and operations to the stage of FIG. 4. Therefore, any repetitive detailed descriptions of the similar configurations and operations will be omitted.

In an embodiment, as shown in FIG. 4, the gate electrode of the second transistor T2 may be connected to the second control node NQ2. In another embodiment, as shown in FIG. 11, a gate electrode of a second transistor T2 of the stage may be connected to the first control node NQ1.

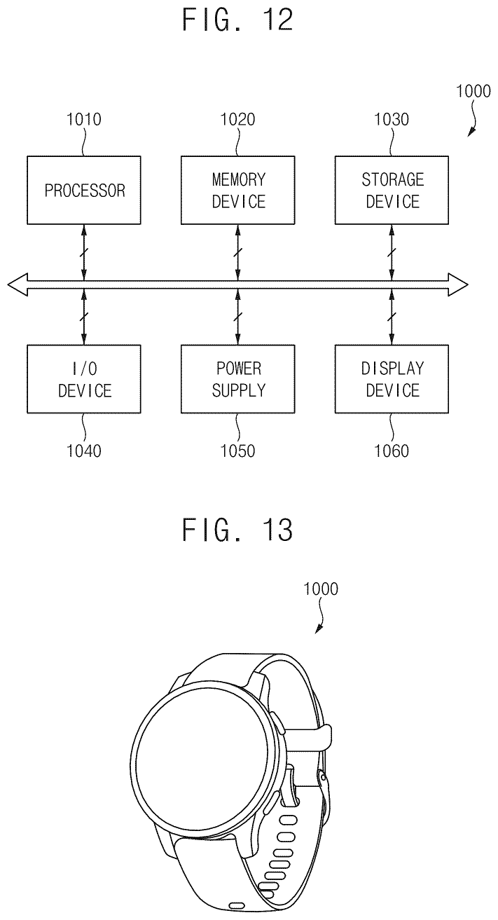

FIG. 12 is a block diagram showing an embodiment of an electronic device 1000. FIG. 13 is a diagram showing an embodiment in which an electronic device 1000 of FIG. 12 is implemented as a smart watch.

Referring to FIGS. 12 and 13, an embodiment of an electronic device 1000 may include a processor 1010, a memory device 1020, a storage device 1030, an input/output I/O device 1040, a power supply 1050, and a display device 10060. The display device 10060 may be the display device 100 of FIG. 1. In addition, the electronic device 1000 may further include a plurality of ports for communicating with a video card, a sound card, a memory card, a universal serial bus USB device, other electronic device, and the like.

In an embodiment, as shown in FIG. 13, the electronic device 1000 may be implemented as a smart watch. However, the electronic device 1000 is not limited thereto. In another embodiment, for example, the electronic device 1000 may be implemented as a cellular phone, a video phone, a smart pad, a smart phone, a tablet personal computer (PC), a car navigation system, a computer monitor, a laptop, a head mounted display (HMD) device, or the like.

The processor 1010 may perform various computing functions. The processor 1010 may be a micro processor, a central processing unit (CPU), an application processor (AP), or the like. The processor 1010 may be coupled to other components via an address bus, a control bus, a data bus, or the like. Further, the processor 1010 may be coupled to an extended bus such as a peripheral component interconnection (PCI) bus.

The memory device 1020 may store data for operations of the electronic device 1000. In an embodiment, for example, the memory device 1020 may include at least one nonvolatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, or the like.

The I/O device 1040 may include an input device such as a keyboard, a keypad, a mouse device, a touch-pad, a touch-screen, or the like, and an output device such as a printer, a speaker, or the like. In some embodiments, the I/O device 1040 may include the display device 10060.

The power supply 1050 may provide power for operations of the electronic device 1000.

The display device 10060 may be connected to other components through buses or other communication links.

Embodiments of the invention may be applied to any display device and any electronic device including the touch panel, e.g., a mobile phone, a smart phone, a tablet computer, a digital television (TV), a three-dimensional (3D) TV, a PC, a home appliance, a laptop computer, a personal digital assistant (PDA), a portable multimedia player (PMP), a digital camera, a music player, a portable game console, a navigation device, etc.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A gate driver including a plurality of stages, wherein each of the stages comprises:
a first transistor including a gate electrode which receives a clock signal, a first electrode which receives an input signal, and a second electrode connected to a control node;
a second transistor including a gate electrode connected to the control node, a first electrode which receives a second low gate voltage, and a second electrode connected to an inversion control node;
a third transistor including a gate electrode connected to the control node, a first electrode which receives a high gate voltage, and a second electrode connected to the inversion control node;
a fourth transistor including a gate electrode connected to the control node, a first electrode which receives the second low gate voltage, and a second electrode connected to a compensation gate output node from which a compensation gate signal is output;
a fifth transistor including a gate electrode connected to the inversion control node, a first electrode which receives the high gate voltage, and a second electrode connected to the compensation gate output node;
a sixth transistor including a gate electrode connected to the compensation gate output node, a first electrode which receives the high gate voltage, and a second electrode connected to a data write gate output node from which a data write gate signal is output; and
a seventh transistor including a gate electrode connected to the inversion control node, a first electrode which receives a gate clock signal, and a second electrode connected to the data write gate output node.

2. The gate driver of claim 1, wherein the input signal is a gate start signal or a previous compensation gate signal.

3. The gate driver of claim 1, wherein the first transistor and the third to seventh transistors are PMOS transistors, and the second transistor is an NMOS transistor.

4. The gate driver of claim 1, wherein the control node includes a first control node and a second control node, and
each of the stages further comprises an eighth transistor including a gate electrode which receives a first low gate voltage, a first electrode connected to the first control node, and a second electrode connected to the second control node.

5. The gate driver of claim 4, wherein the gate electrode of the second transistor is connected to the first control node.

6. The gate driver of claim 4, wherein the gate electrode of the second transistor is connected to the second control node.

7. The gate driver of claim 4, wherein the inversion control node includes a first inversion control node and a second inversion control node, and
each of the stages further includes a ninth transistor including a gate electrode which receives the first low gate voltage, a first electrode connected to the first inversion control node, and a second electrode connected to the second inversion control node.

8. The gate driver of claim 7, wherein the eighth transistor and the ninth transistor are PMOS transistors.

9. The gate driver of claim 7, wherein each of the stages further comprises:
a first capacitor including a first electrode connected to the second control node and a second electrode connected to the compensation gate output node; and
a second capacitor including a first electrode connected to the second inversion control node and a second electrode connected to the data write gate output node.

10. The gate driver of claim 7, wherein the first low gate voltage is equal to the second low gate voltage.

11. The gate driver of claim 7, wherein the first low gate voltage is higher than the second low gate voltage.

12. The gate driver of claim 1, wherein an active pulse of the compensation gate signal includes an active pulse of the data write gate signal.

13. The gate driver of claim 12, wherein an active pulse of the compensation gate signal has a high level, and the active pulse of the data write gate signal has a low level.

14. A display device comprising:
a display panel including a pixel;
a data driver which provides a data voltage to the pixel;
a gate driver which provides a gate signal to the pixel;
an emission driver which provides an emission signal to the pixel; and
a driving controller which controls the data driver, the gate driver, and the emission driver,
wherein the gate driver comprises a plurality of stages, and
wherein each of the stages comprises:
a first transistor including a gate electrode which receives a clock signal, a first electrode which receives an input signal, and a second electrode connected to a control node;
a second transistor including a gate electrode connected to the control node, a first electrode which receives a second low gate voltage, and a second electrode connected to an inversion control node;
a third transistor including a gate electrode connected to the control node, a first electrode which receives a high gate voltage, and a second electrode connected to the inversion control node;
a fourth transistor including a gate electrode connected to the control node, a first electrode which receives the second low gate voltage, and a second electrode connected to a compensation gate output node from which a compensation gate signal is output;
a fifth transistor including a gate electrode connected to the inversion control node, a first electrode which receives the high gate voltage, and a second electrode connected to the compensation gate output node;
a sixth transistor including a gate electrode connected to the compensation gate output node, a first electrode which receives the high gate voltage, and a second electrode connected to a data write gate output node from which a data write gate signal is output; and
a seventh transistor including a gate electrode connected to the inversion control node, a first electrode which receives a gate clock signal, and a second electrode connected to the data write gate output node.

15. The display device of claim 14, wherein the input signal is a gate start signal or a previous compensation gate signal.

16. The display device of claim 14, wherein the first transistor and the third to seventh transistors are PMOS transistors, and the second transistor is an NMOS transistor.

17. The display device of claim 14, wherein the control node includes a first control node and a second control node, and
each of the stages further comprises an eighth transistor including a gate electrode which receives a first low gate voltage, a first electrode connected to the first control node, and a second electrode connected to the second control node.

18. The display device of claim 17, wherein the gate electrode of the second transistor is connected to the first control node.

19. The display device of claim 17, wherein the gate electrode of the second transistor is connected to the second control node.

20. An electronic device comprising:
a display panel including a pixel;
a data driver which provides a data voltage to the pixel;
a gate driver which provides a gate signal to the pixel;
an emission driver which provides an emission signal to the pixel;
a driving controller which controls the data driver, the gate driver, and the emission driver; and
a processor which controls the driving controller,
wherein the gate driver comprises a plurality of stages, and
wherein each of the stages comprises:
a first transistor including a gate electrode which receives a clock signal, a first electrode which receives an input signal, and a second electrode connected to a control node;
a second transistor including a gate electrode connected to the control node, a first electrode which receives a second low gate voltage, and a second electrode connected to an inversion control node;
a third transistor including a gate electrode connected to the control node, a first electrode which receives a high gate voltage, and a second electrode connected to the inversion control node;
a fourth transistor including a gate electrode connected to the control node, a first electrode which receives the second low gate voltage, and a second electrode connected to a compensation gate output node from which a compensation gate signal is output;
a fifth transistor including a gate electrode connected to the inversion control node, a first electrode which receives the high gate voltage, and a second electrode connected to the compensation gate output node;
a sixth transistor including a gate electrode connected to the compensation gate output node, a first electrode which receives the high gate voltage, and a second electrode connected to a data write gate output node from which a data write gate signal is output; and
a seventh transistor including a gate electrode connected to the inversion control node, a first electrode which receives a gate clock signal, and a second electrode connected to the data write gate output node.
